(19) United States
(12) Patent Application Publication
(10) Pub. No.: US 2026/0226968 A1
(43) Pub. Date: Aug. 6, 2026

(54) FREEWHEEL-AXIAL BEARING ASSEMBLY, AND TORQUE CONVERTER

(71) Applicant: Schaeffler Technologies AG & Co. KG, Herzogenaurach (DE)

(72) Inventor: Alexander Reimchen, Herzogenaurach (DE)

(73) Assignee: Schaeffler Technologies AG & Co. KG, Herzogenaurach (DE)

(21) Appl. No.: 19/154,036

(22) PCT Filed: Jan. 10, 2024
(86) PCT No.: PCT/DE2024/100015

§ 371 Date: Aug. 6, 2025

(30) Foreign Application Priority Data
Feb. 7, 2023 (DE) 10 2023 102 964.9

(51) Int. Cl. F16H 45/02; F16C 19/26; F16D 41/069

(52) U.S. Cl. CPC F16H 45/02; F16C 19/26; F16D 41/069; F16C 2361/43

(57) ABSTRACT

A freewheel-axial bearing assembly includes a freewheel and an axial bearing. The freewheel is arranged to transfer a torque based on a relative rotational direction between a stator and a coupling component. The freewheel includes an inner ring, a freewheel sleeve, a clamping body arranged between the inner ring and the freewheel sleeve, and a support ring rotationally fixed to the freewheel sleeve and connected to a stator hub via a first form-fitting connection. The axial bearing includes a bearing disc, and the bearing disc has an integral axial projection form-fittingly connected to a recess in the support ring to form a second form-fitting connection, circumferentially offset relative to the first form-fitting connection.

### CROSS-REFERENCE TO RELATED APPLICATIONS

This application is the United States National Phase of PCT Appln. No. PCT/DE2024/100015 filed Jan. 10, 2024, which claims priority to German Application No. DE102023102964.9 filed Feb. 7, 2023, the entire disclosures of which are incorporated by reference herein.

### TECHNICAL FIELD

The present disclosure relates to a freewheel-axial bearing assembly. Furthermore, the disclosure relates to a torque converter with such a freewheel-axial bearing assembly.

### BACKGROUND

DE 10 2014 209 430 A1 describes a freewheel-axial bearing assembly. The freewheel includes a freewheel sleeve, support rings arranged on the freewheel sleeve in a rotationally fixed manner, an inner ring and a plurality of clamping bodies acting between the freewheel sleeve and the inner ring. The freewheel sleeve has axially projecting drivers extending from a radial portion, each of which forms a contact surface for spring elements that are resiliently arranged between the driver and the clamping bodies. An axial bearing is arranged axially adjacent to the freewheel and is housed in a pot-like receptacle in the freewheel sleeve. The receptacle has latching means that secure the axial bearing for transport.

### SUMMARY

The present disclosure provides a freewheel-axial bearing assembly that is more cost-effective and arranged better on the freewheel.

The disclosed freewheel-axial bearing assembly is embodied more cost-effectively and positioned more reliably and precisely on the freewheel.

The vehicle can be a motor vehicle. The freewheel-axial bearing assembly can be arranged in a drive train of the vehicle.

The axial bearing can be an axial needle bearing. The axial bearing can have rolling elements that are rollable on the axial bearing disc.

The freewheel can be a clamping body freewheel or a roller freewheel. The clamping body can be a clamping roller.

The coupling component can be a shaft, in particular a support shaft. The support shaft can be fixed to the housing.

The inner ring and/or the freewheel sleeve can be rotatable about an axis of rotation. The inner ring can be an inner ring hub or a freewheel hub. The inner ring can be connected to the coupling component, in particular by toothing.

The support ring can be connected in rotationally fixed manner to the freewheel sleeve. The freewheel sleeve can be connected to the support ring in form-fitting, frictional, force-fitting and/or materially bonded manner.

The first form-fitting connection can connect the support ring and the connection component in radially, axially and/or rotationally fixed manner. The first form-fitting connection can transmit torque between the connection component and the support ring.

The second form-fitting connection can connect the axial bearing disc and the support ring in radially, axially and/or rotationally fixed manner. The second form-fitting connection can center the axial bearing relative to the support ring.

In an example embodiment, the first form-fitting connection may have at least two circumferentially spaced-apart form-fitting means on the support ring that can engage in at least two correspondingly circumferentially spaced-apart counter form-fitting means in the connection component. The first form-fitting connection can have form-fitting means arranged evenly distributed over the circumference of the support ring. The counter form-fitting means can be arranged evenly distributed over the circumference of the connection component. The form-fitting means and counter form-fitting means may be identical in number.

In one embodiment, the form-fitting means may each be embodied as an integral radial projection on the support ring and the counter form-fitting means may each be embodied as a radial recess on the connection component. The form-fitting means can also each be embodied as a radial recess on the support ring and the counter form-fitting means can each be embodied as a radial projection on the connection component. The first form-fitting connection can be a spline connection. The radial projection can originate from an outer circumference or inner circumference of the support ring. The radial recess can be arranged on an inner circumference or outer circumference of the connection component.

In one embodiment, the securing means may be arranged circumferentially between the two form-fitting means. The securing means can be arranged at least partially axially overlapping the form-fitting means.

In an example embodiment, the securing means is arranged circumferentially directly adjacent to at least one of the form-fitting means. The form-fitting means can form a circumferential torsion limit for the securing means. This allows limited torsional mobility between the axial bearing disc and the support ring. The axial bearing disc and the support ring can be connected to each other in rotationally fixed manner. The rotationally fixed connection can be formed at least in one circumferential direction by the securing means and the form-fitting means located immediately adjacent thereto.

In one embodiment, the securing means may be embodied as an axial projection. The axial projection may axially project on an outer circumference of the axial bearing disc. The axial projection can be integrally connected to a radial region of the axial bearing disc on which the rolling elements are rollable.

In an example embodiment, the axial projection may engage in a form-fitting manner in a corresponding recess in the support ring to form the second form-fitting connection. The recess can be provided on an outer circumference of the support ring. The recess may be a circumferentially limited radial depression in the support ring.

In one embodiment, the recess may directly circumferentially adjoin the radial projection. The recess may have a circumferential extent that is smaller than, equal to, or greater than a circumferential extent of the radial projection.

Furthermore, the present disclosure includes a torque converter including an impeller, a turbine, a stator and a freewheel-axial bearing assembly with at least one of the preceding features.

In an example embodiment, the stator may form the connection component. The connection component can be a stator hub of the stator. The connection component can be a transmission component of a gearbox.

Further advantages and embodiments of the present disclosure are apparent from the description of the figures and the drawings.

### BRIEF DESCRIPTION OF THE DRAWINGS

The present disclosure is described in detail below with reference to the drawings. In the drawings:

FIG. 1 shows a half section of a torque converter;

FIG. 2 shows a detail from FIG. 1 in an enlarged view; and

FIG. 3 shows a stator with a freewheel-axial bearing assembly in a further embodiment.

### DETAILED DESCRIPTION

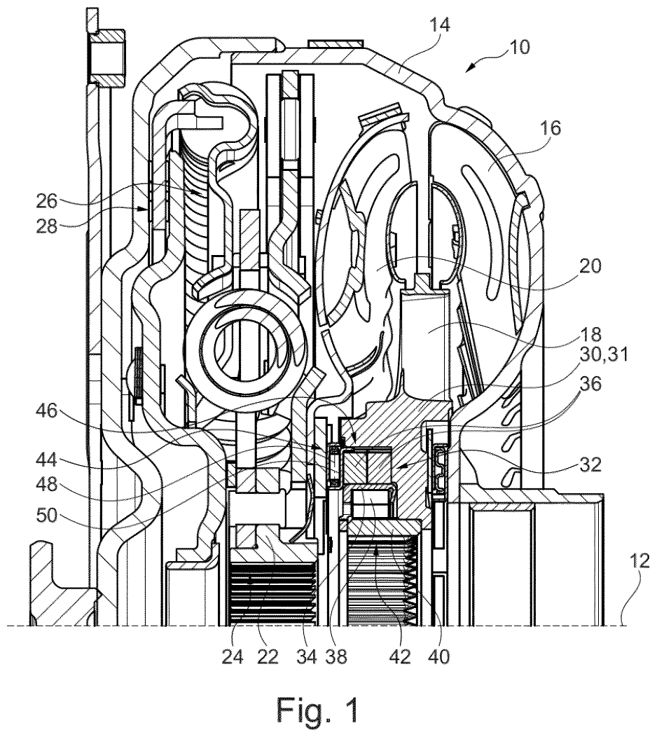

FIG. 1 shows a half section of a torque converter. The torque converter 10 has a torque converter housing 14 that is rotatable about an axis of rotation 12 and may be arranged in torque-transmitting manner between a drive element, for example an internal combustion engine, and an output element, for example a transmission. The torque converter housing 14 accommodates an impeller 16 and a turbine 20 hydrodynamically connected to the impeller 16 via a stator 18.

A torque introduced via the torque converter housing 14 is hydrodynamically transmitted via the impeller 16, which is firmly connected to the torque converter housing 14, to the turbine 20, which is coupled to an output hub 22. The output hub 22 has internal toothing 24 with which the output hub 22 is connected to an output shaft, for example a transmission input shaft, in torque-transmitting manner.

A torsional vibration damper 26 is functionally arranged with respect to torque transmission between the impeller 16 and the output hub 22 within the torque converter housing 14. Torque transmission via the impeller 16 and turbine 20 can be bypassed by a converter lock-up clutch 28. When the converter lock-up clutch 28 is engaged, the torque introduced by the torque converter housing 14 is transmitted to the output hub 22 via the converter lock-up clutch 28 and the torsional vibration damper 26. Torque transmission via the hydrodynamic region of the torque converter 10, i.e., the impeller 16, stator 18 and turbine 20, is bypassed. When the converter lock-up clutch 28 is disengaged, the torque is transmitted via the hydrodynamic region.

The stator 18 is connected via a stator hub 30 to a freewheel 32 which is designed to transfer a torque on the basis of a relative rotational direction between a connection component 31, here the stator hub 30, and a coupling component not shown here. The freewheel 32 has a freewheel sleeve 34, the outer diameter of which receives support rings 36 in at least rotationally fixed manner by way of a press fit, a plurality of clamping bodies 38 and an inner ring 40. The inner ring 40 is embodied with internal toothing 42, via which torque is transmitted to a support shaft arranged on the transmission side and forming the coupling component.

The clamping bodies 38 are functionally arranged between the inner ring 40 and the freewheel sleeve 34 and, in a first relative rotational direction between the inner ring 40 and the freewheel sleeve 34, couple the two to each other in torque-transmitting manner and, in an opposite second relative rotational direction, decouple the two to allow torsional movement relative to each other.

The freewheel 32 forms a freewheel-axial bearing assembly 46 with an axial bearing 44. The axial bearing 44 has a plurality of rolling elements 48 that are rollable on an axial bearing disk 50 of the axial bearing 44 that axially faces the freewheel 32.

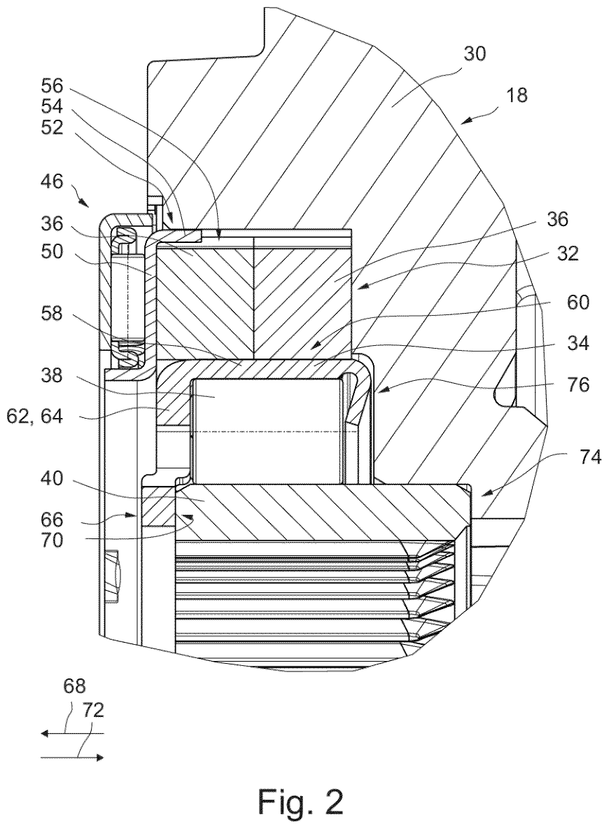

FIG. 2 shows a detail from FIG. 1 in an enlarged view. The freewheel-axial bearing assembly 46 is arranged on the stator 18. At least one securing means 52 is provided on the axial bearing disc 50, with which the axial bearing disc 50 is connected to the support ring 36 in a form-fitting manner. The securing means 52 includes at least one axial projection 54 that engages in a corresponding recess 56 in the support ring 36 in a form-fitting manner.

The freewheel 32 includes the support rings 36 received on an outer circumference 60 of the freewheel sleeve 34, the freewheel sleeve 34, the clamping bodies 38 and the inner ring 40. The freewheel sleeve 34 has an axial portion 58, the outer circumference 60 of which receives the support rings 36 and on the inner circumference of which the clamping bodies 38 are rollable in the second relative rotational direction. The axial portion 58 is followed by a radial portion 62 that forms a rim 64 of the freewheel sleeve 34.

The radial portion 62 has a positioning region 66 on which the inner ring 40 is axially fixed in a first axial direction 68. The positioning region 66 includes an axial side surface 70 of the radial portion 62, against which the inner ring 40 rests. In the opposite second axial direction 72, the inner ring 40 is axially fixed via a radial projection 74 of the stator hub 30.

The clamping bodies 38 are each axially fixed in the first axial direction 68 by the radial portion 62. In the opposite second axial direction 72, the clamping bodies 38 are axially fixed by a retaining portion 76 of the freewheel sleeve 34. The retaining portion 76, like the radial portion 62, is integrally formed from the freewheel sleeve 34 and may extend radially inwardly from the axial portion 58, in particular on a side axially opposite the radial portion 62 with respect to the clamping body 38.

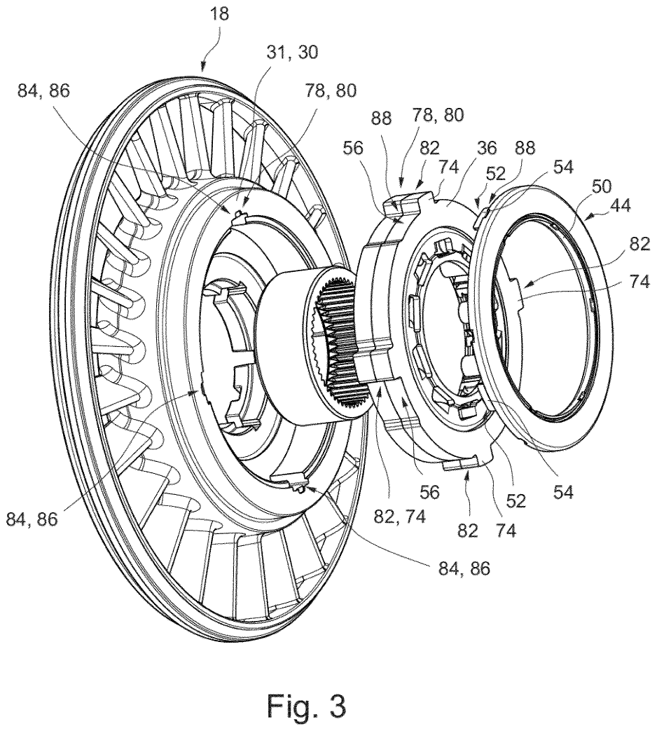

FIG. 3 shows a stator with a freewheel-axial bearing assembly in a further embodiment. The support rings 36 are each connected in a form-fitting manner to the connection component 31, here the stator hub 30 of the stator 18, via a first form-fitting connection 78. The first form-fitting connection 78 creates a rotationally fixed and torque-transmitting connection between the support ring 36 and the connection component 31.

The first form-fitting connection 78 may be a spline connection 80 having a total of four circumferentially spaced-apart form-fitting means 82 on the support ring 36 that are arranged evenly distributed over the circumference of the respective support ring 36, and that engage in four circumferentially spaced-apart counter form-fitting means 84 in the connection component 31 in a form-fitting manner, which counter form-fitting means are arranged evenly distributed over the circumference of the connection component 31. The form-fitting means 82 are each embodied as an integral radial projection 74 on the support ring 36 and the counter form-fitting means 84 are each embodied as a radial recess 86 on the connection component 31.

A plurality of securing means 52 project integrally from the axial bearing disc 50, said securing means being connected to the support ring 36 in a form-fitting manner, thereby forming a second form-fitting connection 88 which is offset circumferentially relative to the first form-fitting connection 78. The securing means 52 may be arranged circumferentially between and, for example, circumferentially adjacent to the form-fitting means 82. The second form-fitting connection 88 causes the axial bearing 44 to be centered relative to the support ring 36.

The securing means 52 are each embodied as an axial projection 54 and each engage in form-fitting manner in corresponding recesses 56 in the support ring 36 to form the second form-fitting connection 88, and the recesses 56 on the support ring 36 each circumferentially adjoin the radial projections 74.

### REFERENCE NUMERALS

10 Torque converter
12 Axis of rotation
14 Torque converter housing
16 Impeller
18 Stator
20 Turbine
22 Output hub
24 Internal toothing
26 Torsional vibration damper
28 Converter lock-up clutch
30 Stator hub
31 Connection component
32 Freewheel
34 Freewheel sleeve
36 Support ring
38 Clamping body
40 Inner ring
42 Internal toothing
44 Axial bearing
46 Freewheel-axial bearing assembly
48 Rolling element
50 Axial bearing disc
52 Securing means
54 Axial projection
56 Recess
58 Axial portion
60 Outer circumference
62 Radial portion
64 Rim
66 Positioning region
68 First axial direction
70 Axial side surface
72 Second axial direction
74 Radial projection
76 Retaining portion
78 First form-fitting connection
80 Spline connection
82 Form-fitting means
84 Counter form-fitting means
86 Radial recess
88 Second form-fitting connection

1. A freewheel-axial bearing assembly for a vehicle having:
a freewheel which is designed to transfer a torque on the basis of a relative rotational direction between a connection component and a coupling component and which comprises an inner ring, a freewheel sleeve, at least one clamping body that is functionally arranged between the inner ring and the freewheel sleeve, and a support ring that is connected to the freewheel sleeve and can be connected to the connection component via a first form-fitting connection,
and an axial bearing with at least one axial bearing disc, wherein:
at least one securing means projects integrally from the axial bearing disc, said securing means being connected to the support ring in a form-fitting manner, thereby forming a second form-fitting connection which is offset circumferentially relative to the first form-fitting connection.

2. The freewheel-axial bearing assembly according to claim 1, wherein the first form-fitting connection has at least two circumferentially spaced-apart form-fitting means on the support ring that can engage in at least two correspondingly circumferentially spaced-apart counter form-fitting means in the connection component.

3. The freewheel-axial bearing assembly according to claim 2, wherein the form-fitting means are each embodied as an integral radial projection on the support ring and the counter form-fitting means are each embodied as a radial recess on the connection component.

4. The freewheel-axial bearing assembly according to claim 2, wherein the securing means is arranged circumferentially between the two form-fitting means.

5. The freewheel-axial bearing assembly according to claim 2, wherein the securing means is arranged circumferentially directly adjacent to at least one of the form-fitting means.

6. The freewheel-axial bearing assembly according to claim 1, wherein the securing means is embodied as an axial projection.

7. The freewheel-axial bearing assembly according to claim 6, the axial projection engages in a form-fitting manner to form a corresponding recess in the support ring to form the second form-fitting connection.

8. The freewheel-axial bearing assembly according to claim 3, wherein the recess circumferentially directly adjoins the radial projection.

9. A torque converter having
an impeller,
a turbine,
a stator, and
a freewheel-axial bearing assembly according to claim 1.

10. The torque converter according to claim 9, wherein the stator forms the connection component .

11. A torque converter, comprising:
an impeller;
a turbine;
a stator comprising a stator hub;
a freewheel-axial bearing assembly, comprising:
a freewheel arranged to transfer a torque based on a relative rotational direction between the stator and a coupling component, the freewheel comprising:
an inner ring;
a freewheel sleeve;
a clamping body arranged between the inner ring and the freewheel sleeve; and
a support ring rotationally fixed to the freewheel sleeve and connected to the stator hub via a first form-fitting connection; and
an axial bearing comprising a bearing disc, the bearing disc comprising an integral axial projection form-fittingly connected to a recess in the support ring to form a second form-fitting connection, circumferentially offset relative to the first form-fitting connection.

12. The torque converter of claim 11, wherein the support ring comprises an integral radial projection engaged in a radial recess in the stator hub to form the first form-fitting connection.

13. The torque converter of claim 12, wherein the support ring further comprises a second integral radial projection, and the integral axial projection is arranged circumferentially between the integral radial projection and the second integral radial projection.

14. The torque converter of claim 12, wherein the integral axial projection is arranged circumferentially directly adjacent to the integral radial projection.

15. The torque converter of claim 12, wherein the recess in the support ring circumferentially directly adjoins the integral radial projection.
